(19) United States
(12) Patent Application Publication
(10) Pub. No.: US 2019/0099935 A1
(43) Pub. Date: Apr. 4, 2019

(54) CALENDER STACK AND METHOD FOR CALENDERING A PLASTIC FILM

(71) Applicant: KRAUSSMAFFEI BERSTORFF GMBH, 30625 Hannover (DE)

(72) Inventors: Andreas Friesen, Uetze (DE); JOACHIM THOLE, Hannover (DE)

(73) Assignee: KRAUSSMAFFEI BERSTORFF GMBH, 30625 Hannover (DE)

(21) Appl. No.: 16/082,835

(22) PCT Filed: Feb. 21, 2017
(86) PCT No.: PCT/EP2017/053837

§ 371 Date: Sep. 6, 2018

(30) Foreign Application Priority Data
Mar. 21, 2016 (DE) 10 2016 105 178.0

(51) Int. Cl. B29C 43/24; B29L 7/00; B29K 69/00; B29K 67/00; B29C 43/52; B29C 43/34

(52) U.S. Cl. CPC B29C 47/906; B29C 47/886; B29C 47/0021; B29C 47/8845; B29K 2995/0026; B29K 2995/0073; B29C 2043/3433; B29C 43/24; B29C 47/14; B29K 2069/00; B29K 2067/003; B29C 43/52; B29L 2007/008

(57) ABSTRACT

The invention relates to a calender stack for an extruded material web (51) made from thermoplastic, in particular a film web, having (a) a stand (1) which has (i) a first guide rail set (2) which comprises two arcuate first guide rails (2′, 2″) and (ii) a second guide rail set (3) which comprises two arcuate second guide rails (3′, 3″), (b) a first calender roll (8) which can be rotated about a first calender roll rotational axis D8) and is mounted on the stand (1), (c) a second calender roll (9) which forms a calender with the first calender roll (8) and is fastened to the stand (1), (d) an adjusting roll (14) which can be rotated about an adjusting roll rotational axis (D14) and is mounted on the stand (1), and (e) a supporting device (34), on which the stand (1) is mounted rotatably in such a way that the first calender roll rotational axis (D8) remains stationary during a rotation of the stand (1). According to the invention, the stand (1) is configured in such a way that the adjusting roll (14) can be positioned at an angle of inclination (α) of at least 55°, wherein the angle of inclination (α) is formed firstly between a horizontal which runs perpendicularly with respect to the first calender roll rotational axis (D8) and through the first calender roll rotational axis (D8), and secondly a straight line which runs perpendicularly with respect to the first calender roll rotational axis (D8) through the first calender roll rotational axis (D8) and through the adjusting roll rotational axis (D14).

The invention relates to a calender stack for an extruded material web made of thermoplastic, in particular a film web (a), having (a) a stand, which has (i) a first set of guide rails comprising two circular arc-shaped first guide rails and (ii) a second set of guide rails comprising two circular arc-shaped second guide rails, (b) a first calender roller that can be rotated about a first calender roller rotational axis and is mounted on the stand, (c) a second calender roller which forms a calender with the first calender roller and is fixed to or mounted on the stand, (d) an adjustment roller that can be rotated about an adjustment roller rotating axis and is mounted on the stand, and (e) a support device, on which the stand is rotatably mounted such that the first calender roller rotational axis remains stationary during a rotation of the stand.

A calender stack of the above type is known from DE 197 52 524 A1. A disadvantage of this calender stack is that it only allows transparent films with a particularly high degree of transparency to be produced in a limited way.

The object of the invention is to specify a calender stack by means of which the transparency of the film can be increased.

The invention achieves the object by means of a calender stack of generic kind, in which the stand is designed such that the adjustment roller can be positioned, in particular automatically, at an inclination angle of at least 55°, wherein the inclination angle is formed between on the one hand a horizontal line that runs perpendicular to the first calender roller rotational axis and passes through the first calender roller rotational axis, and on the other hand a straight line that runs perpendicular to the first calender roller rotational axis and passes through the first calender roller rotational axis and through the adjustment roller rotational axis. This enables a small wrap-around angle of less than 90° to be obtained, even if a second calender roller rotational axis of the second calender roller and the first calender roller rotational axis are positioned at the same height. This is the case in particular when the second calender roller rotational axis and the first calender roller rotational axis lie in a horizontal plane, for example in order to produce thin films.

The wrap-around angle is the angle at which the material web is in contact with the first calender roller. The first calender roller is preferably temperature controlled, in particular cooled, so that the material web is cooled down further, the greater the wrap-around angle. Hence it would actually be expected that a large wrap-around angle would be advantageous. It has been shown, however, that the thermal conductivity of the material web is usually so small that the first calender roller is only weakly capable of cooling the side of the material web, which faces away from the first calender roller. It has therefore turned out to be a positive feature for a smaller wrap-around angle to be chosen. The known calender stack, however, is not capable of setting sufficiently small wrap-around angles for all positions of the adjustment roller and/or the second calender roller.

The calender stack according to the invention is able to set small wrap-around angles of less than 90°, in particular of less than 80°, so that the material web can be diverted from the first calender roller onto the adjustment roller after a short period of time. In accordance with a preferred embodiment, the adjustment roller is also cooled, so that the material web can be rapidly cooled from both sides. This leads to the temperature falling below the glass transition temperature particularly fast, and thus to a high level of transparency of the material web.

In accordance with a preferred embodiment, the calender stack has a drive unit, which interacts in a positive-fitting manner with a toothed gearing system that is implemented on the stand, so that the stand can be automatically rotated. This design enables a position of the second calender roller to be spatially adjusted automatically. It should be noted that the first calender roller rotational axis of the first calender roller does not move in space during a movement of the stand by means of the drive unit. This is to be understood in the sense that the location of the first calender roller rotational axis is not changed in the technical sense. Although it is possible for a measurable change to occur in the first calender roller rotational axis when the stand is moving, this is so small as to be irrelevant to the function of the first calender roller.

Preferably, the first set of guide rails comprises a first supplementary guide rail, wherein the second set of guide rails has a second supplementary rail and one of the first guide rails is part of a rotational guide for rotating the stand, and wherein on another of the guide rails a guide carriage is guided, by means of which the adjustment roller is moveably mounted on a circular arc on the stand, the centre of the arc being coincident with the first calender roller rotational axis. The feature that the centre of the circular arc is coincident with the first calender roller rotational axis is defined in particular to mean that, although it is possible and preferable that the central point lies exactly on the first calender roller rotational axis, this is not strictly necessary. In particular, the centre of the circular arc can be spaced a distance apart from the first calender roller rotational axis, for example a distance of less than 50 microns.

The term supplementary guide rail is defined as such because this rail is not known from the prior art. It therefore does not mean, in particular, that it could be optional.

The second calender roller is preferably fixedly connected to the stand. Alternatively, it is possible for the adjustment roller to be moveably attached to the stand on a circular arc by means of a second carriage. In this case, it is not necessary for the stand itself to be designed to be moveable. The feature that the adjustment roller is moveably attached to the stand on a circular arc by means of the carriage, means in particular that the adjustment roller is guided on the stand on a circular arc by means of the carriage.

It is advantageous if the toothed gearing system is implemented on at least one guide ran. It is particularly advantageous if the toothed guide rail is fixed to the remaining part of the stand, in particular in a detachable manner. For example, the toothed guide rail is tightly screwed and/or riveted to the remaining part of the stand. This has the advantage that the toothing system can be manufactured particularly simply. The toothing system can also be particularly easily adjusted relative to the rest of the stand.

It is advantageous if the first calender roller and/or the adjustment roller are connected to a cooling device for cooling the rollers. The cooling device is part of the calender stack.

Also provided in accordance with the invention is a film production device having an extruder for producing an extruded material web, in particular a film web, of thermoplastic and having a calender stack according to the invention, which is arranged downstream of the extruder in a material flow direction of the material web for smoothing the material web. For example, the extruder comprises a wide-slit nozzle for producing the extruded material web.

Also provided in accordance with the invention is a method for film production, having the steps (i) production of an extruded material web from thermoplastic material and (II) smoothing the material web with a calender stack according to the invention, wherein a wrap-around angle is less than 85°, in particular less than 75°. The wrap-around angle designates the angle at which the material web rests in contact with the first calender roller.

Preferably, the first calender roller and/or adjustment roller are cooled to a temperature that is below a glass transition temperature of the thermoplastic material. It is also advantageous if the temperature is at least 10 Kelvin below this glass transition temperature.

It is particularly advantageous if the thermoplastic material is transparent. For example, the plastic can be polycarbonate or polyethylene-terephthalate.

Hereafter the invention is explained in more detail by reference to the accompanying drawings. They show:

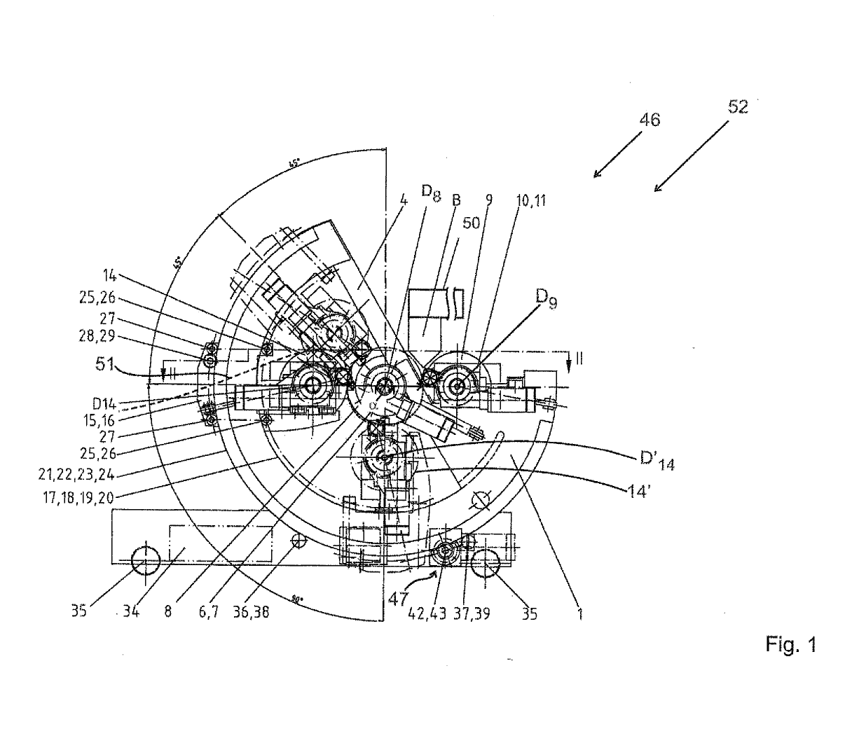

FIG. 1 a side view of a calender stack according to the invention in a first orientation position,

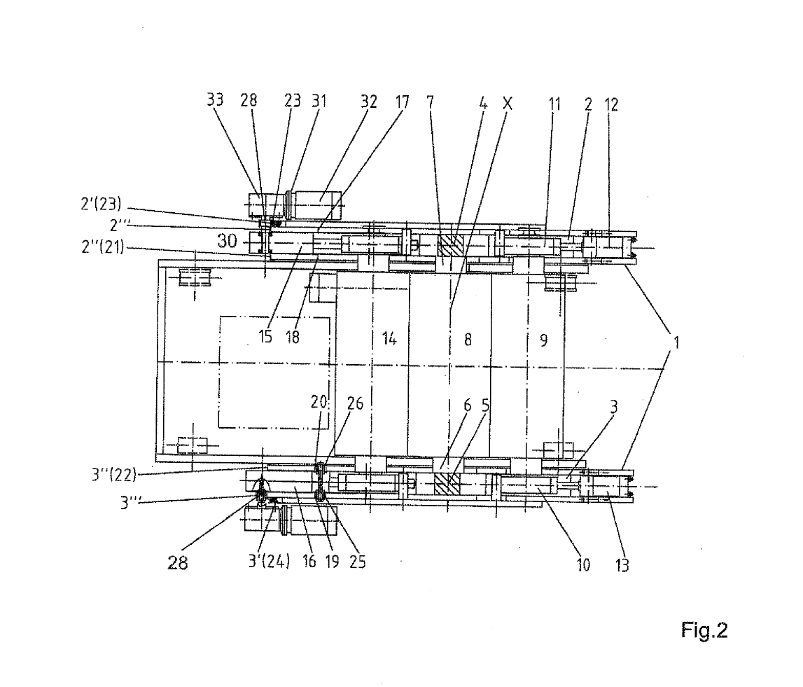

FIG. 2 a section II-II in accordance with FIG. 1,

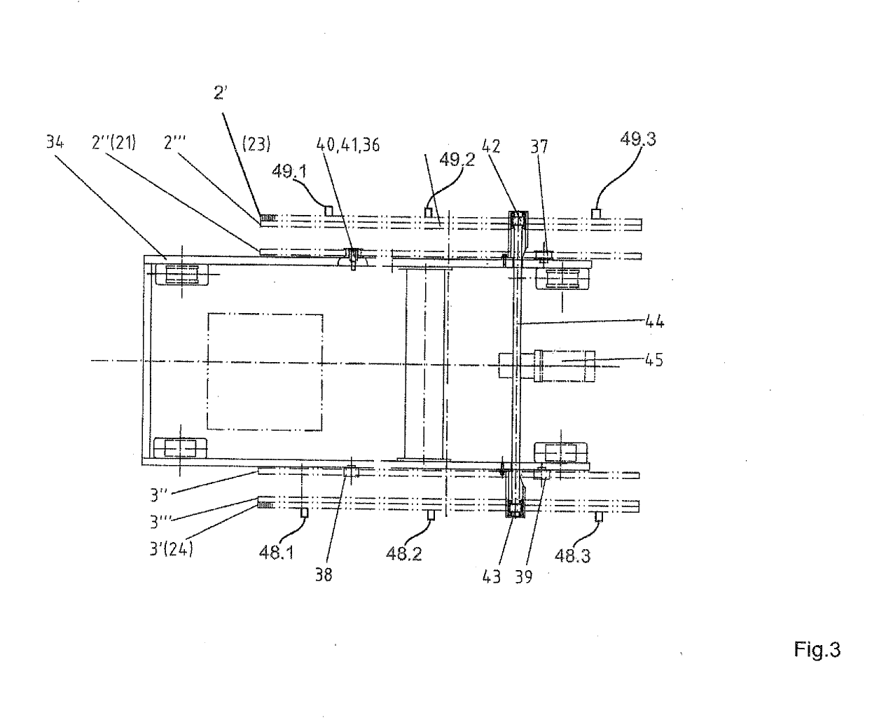

FIG. 3 a view of the support device of the calender stack and

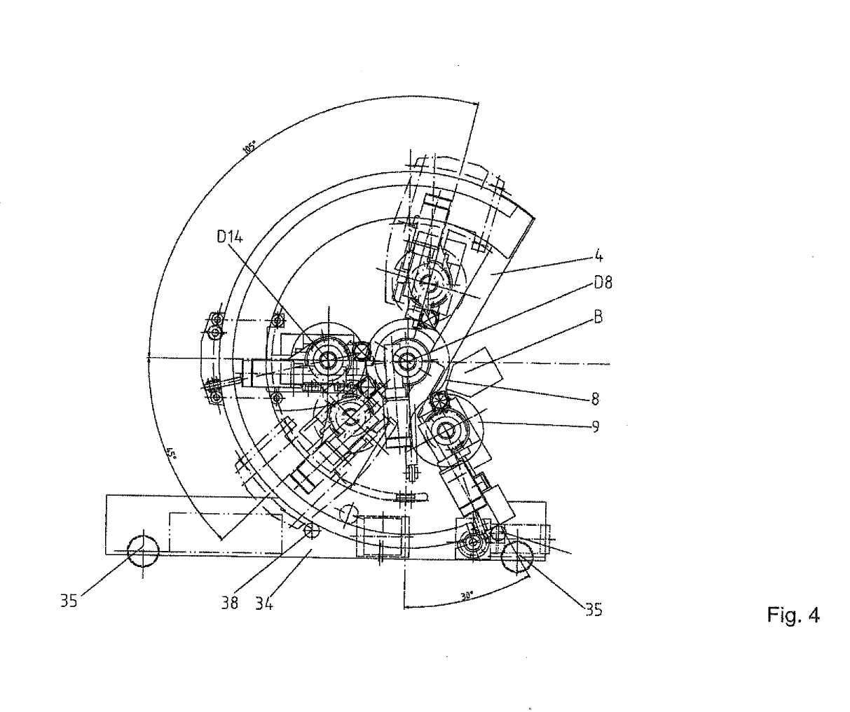

FIG. 4 the calender stack in a rotated position relative to FIG. 1, in order to obtain a particularly small wrap-around angle.

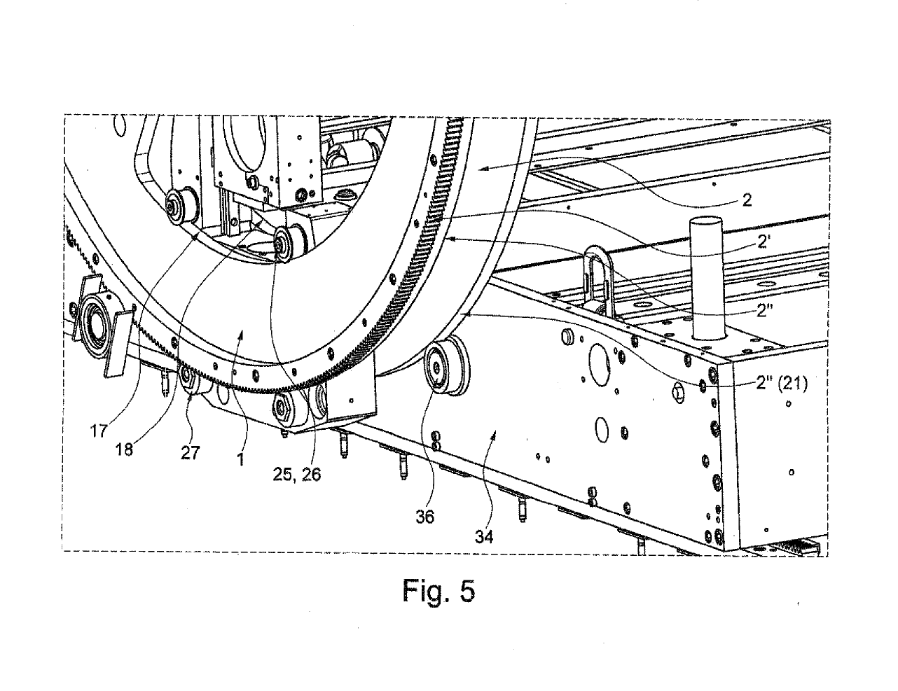

FIG. 5 shows a perspective detail view of the stand and the support device that bears the stand,

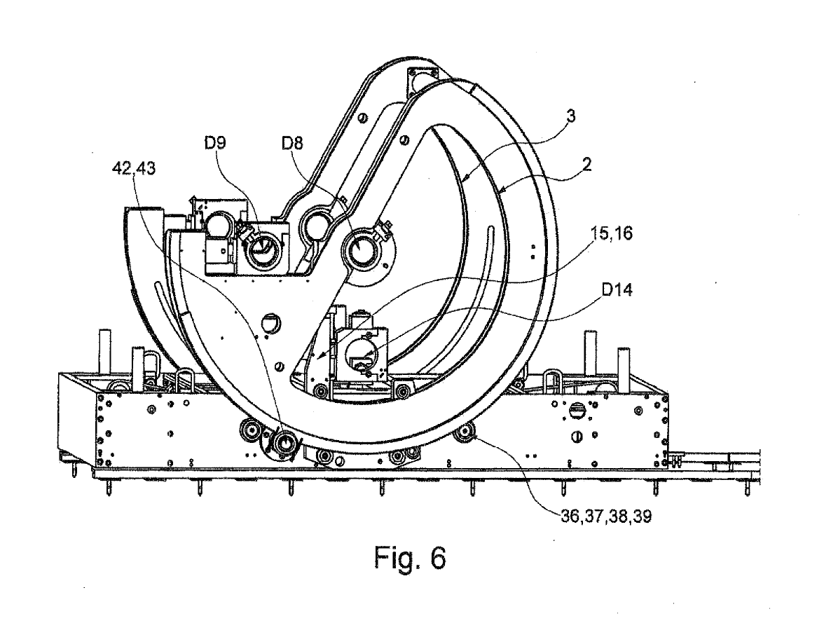

FIG. 6 shows a perspective full view of the calender stack and

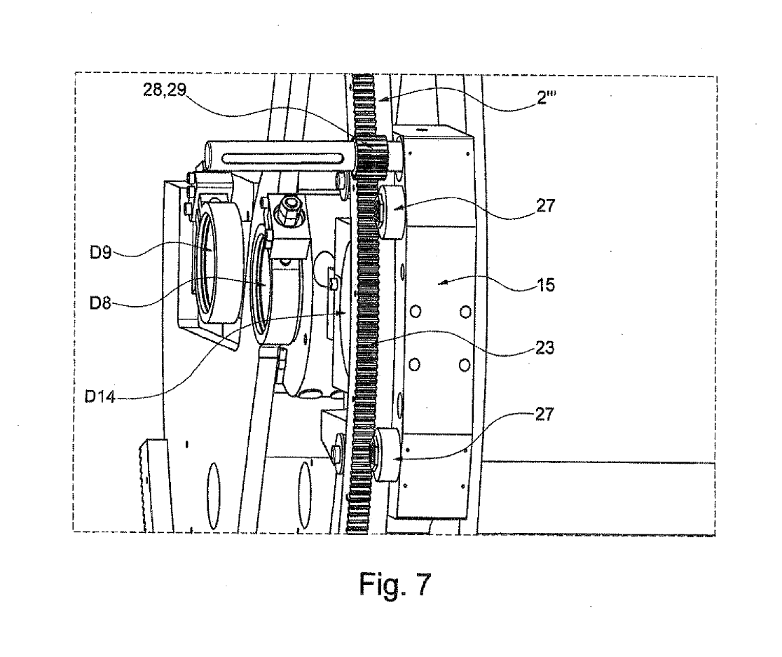

FIG. 7 shows details of the drive for the stand.

FIG. 1 shows a calender stack 46, having a stand 1. This stand 1 comprises a first guide rail set 2 (see FIG. 2) that comprises two circular arc-shaped first guide rails 2′, 2″. The stand also comprises a second guide rail set 3 that comprises two circular arc-shaped second guide rails 3′, 3″. The first two guide rails 2′, 2″ are arranged spaced apart from each other and parallel to each other. The guide rails 2′, 2″, 3′ and 3″ run in circular arcs, which means that they extend along a circular arc. They can be produced, for example, from a flat material. The two guide rail sets 2, 3 each have a cross beam 4, 5, with respect to which they are laterally arranged and which extends in the manner of a chord of a circle. The two guide rail sets 2, 3 are connected to each other.

A first calender roller 8 is rotatably mounted on the two cross beams 4, 5 by means of bearings 6, 7. The calender stack comprises a drive, not shown in the drawing, by means of which the calender roller 8 can be rotatably driven. The calender roller 8 is rotatably mounted about a first calender roller rotational axis D₈. In between the two guide rail sets 2′, 2″ and 3′, 3″, and the two guide rails sets 2, 3, respectively, adjusting devices 12, 13 are arranged, which are used for the adjustment of a second calender roller 9. The second calender roller 9 is mounted in bearings 10, 11 about a second calender roller rotational axis D₉. The bearings 10, 11 hold the second calender roller 9 and can be moved by the adjusting devices 12, 13 (see FIG. 2), so that a gap between the first calender roller 8 and the second calender roller 9 can be adjusted by means of the adjusting devices 12, 13. The adjusting devices 12, 13 can comprise a motor for the purpose, but this is not essential.

The second calender roller 9 is radially adjustable relative to the first calender roller rotational axis D by means of the adjusting devices 12, 13. The calender stack 46 also comprises an adjustment roller 14, which is pivotably mounted on a circular arc about the first calender roller rotational axis D₈ by means of guide carriages 15, 16 on the guide rail sets 2, 3. The adjustment roller 14 is attached to the ends of the guide carriages 15, 16 and is fixed to the first calender roller 8 so as to be adjustable in a radial direction. In this way, the distance between the first calender roller 8 and the adjustment roller 14 can be adjusted.

FIG. 2 shows that the first set of guide rails 2 comprises a first supplementary guide rail 2′″. The second set of guide rails 3 has a second supplementary guide rail 3′″. The guide carriage 15 runs on a guide track 17 which is implemented on the first supplementary guide rail 2″, and on a guide rail 18 which is implemented on the first guide rail 2″. The second guide carriage 16 runs on a guide track 19 which is implemented on the second supplementary guide rail 3″, and on a guide rail 20 which is implemented on the second guide rail 3″. It can be seen that the first guide rail 2′ and the second guide rail 3′ each have a toothing system 23 or 24, but the other guide rails do not.

The guide tracks 17, 18, 19, 20 are in the shape of circular arcs and the centre of the arcs is coincident with the first calender roller rotational axis D₈.

The guide carriage 16 comprises rollers 25, 26, with which it runs on the guide tracks 19, 20. Externally, the guide carriage 16 is also guided via two rollers 27. The guide carriage 15 has a toothed pinion 28, by means of which a position of the guide carriage 15 can be adjusted in the circumferential direction. The pinion 28 is connected by means of a shaft 30 to a further pinion 29, which meshes with the toothing system 24. The shaft 30 is connected to a motorized drive 31, so that the guide carriages 15, 16 can move simultaneously. This then causes the adjustment roller 14 to move on the circular arc.

FIG. 3 shows that the stand 1 rests on support rollers 36, 37, 38, 39 of a support device 34, which in the present case is designed as a sub-frame. The stand 1 can be pivoted by means of the support device 34 about the first calender roller rotational axis D₈. The support rollers 36, 37 are designed with side walls 40, 41, with which they additional enclose the guide rail 2″ at the sides.

The guide rail 2″ has an outer guide track 21, which is in the shape of a circular arc. A centre of the are is the first calender roller rotational axis D₈. The stand 1 extends via the outer guide track 21 on the support rollers 36, 37. The second guide rail 3″ has an outer guide track 22, with which it rests against the support rollers 38, 39. The calender stack 46 has a pivotable drive 47, comprising two driving pinions 42, 43 that are mounted on the sub-frame 43. The two driving pinions 42, 43 are connected by means of a drive shaft 44, which is coupled with a drive unit 45. The driving pinions 42, 43 engage with the toothing systems 23, 24 of the guide rails 2′ and 3′.

The toothed guide rail 3′ is bolted to the second supplementary guide rail 3″ by means of schematically indicated bolts 48.1, 48.2, 48.3. In the same way, the guide rail 2′ is bolted to the guide rail 2′″ by means of bolts 49.1, 49.2, 49.3.

FIG. 1 also shows a schematic diagram of an extruder 50 with the wide-slit nozzle B thereof. In the case shown in FIG. 1 the nozzle outlet is directed vertically downwards and the two calender rollers 8, 9 are aligned horizontally to each other, to receive the material web emerging from the wide-slit nozzle B. A material web 51 is shown purely schematically by a dashed line. It can be seen that the material web 51 rests in contact with the first calender roller 8 with a wrap-around angle α, wherein in the present case α=180°. Thereafter the material web 51 is removed from the adjustment roller 14.

The adjustment roller, which is labelled as 14′, is shown by a dashed line in a second position, in which the wrap-around angle α′=90°. The position shown by the dashed line cannot be reached using calender stacks according to the prior art. The adjustment roller 14 is moved from the position marked with solid lines into the position marked with dashed lines by the guide carriages 15, 16 being moved along the guide rails. The extruder 50 and the calender stack 46 are part of a film production device 52 according to the invention.

An independent subject matter of the present application is a calender stack of generic kind, in which the second calender roller and the adjustment roller are mounted such that a wrap-around angle of <90°, in particular <80°, can be set.

FIG. 5 shows that the first guide rail 2′ is bolted on, so that it can be manufactured and assembled particularly simply.

FIG. 6 shows a full perspective view of the calender stack.

FIG. 7 allows identification of the pinions 28, 29, which mesh with the teeth 23.

### LIST OF REFERENCE NUMERALS

1 Stand
2 first set of guide rails
2′ first guide rail
2″ first guide rail
2′″ first supplementary guide rail
3 second set of guide rails
3′ second guide rail
3″ second guide rail
3′″ second supplementary guide rail
4, 5 cross beam
6, 7 bearing
8 first calender roller
9 second calender roller
10,11 bearing
12, 13 adjustment device
14 adjustment roller
15, 16 guide carriages
17,18,19,20 inner guide tracks
21,22 outer guide tracks
23, 24 toothing system
25, 26, 27 rollers
28, 29 pinions
30 shaft
31 motorized drive
32 motor
33 angular gear
34 support device
35 running wheels
36,37,38,39 support roller
40, 41 side wall
42, 43 driving pinions
44 drive shaft
45 drive unit
46 calender stack
47 swivel drive
48,49 bolt
50 extruder
51 material web
52 film production device
α wrap-around angle
B wide-slit nozzle
D rotational axis

1.-10. (canceled)

11. A calender stack for an extruded material web made of thermoplastic, in particular a film web, said calender stack comprising:
a stand comprising a first guide rail set which includes two arc-shaped first guide rails and an untoothed first supplementary guide rail, and a second guide rail set which includes two arc-shaped second guide rails and an untoothed second supplementary guide rail, said stand having a toothing system, wherein one of the first guide rails of the first guide rail set is part of a rotational guide for rotating the stand, and wherein the other one of the first guide rails is toothed;
a first calender roller configured for rotation about a first calender roller rotational axis and mounted on the stand;
a second calender roller configured for rotation about a second calender roller rotational axis, said second calender roller being fixed to the stand and forming a calender with the first calender roller,
an adjustment roller configured for rotation about an adjustment roller rotational axis and mounted on the stand;
a supporting device, said stand being rotatably mounted on the supporting device such that during rotation of the stand the first calender roller rotational axis remains stationary;
a drive unit interacting in a positive-fitting manner with the toothing system on the stand, so that the stand is automatically rotatable; and
a guide carriage guided on the other one of the first guide rails and mounting the adjustment roller on the stand for movement on a circular arc which is defined by a centre in coincidence with the first calender roller rotational axis, said guide carriage moving on the first supplementary guide rail such that the adjustment roller and the second calender roller are positionable at a wrap-around angle of less than 75°,
wherein the stand is configured to enable positioning of the adjustment roller at an inclination angle of at least 55° when the first and second calender roller rotational axes are oriented horizontally with respect to each other, with the inclination angle being formed between a horizontal extending in perpendicular relation to the first calender roller rotational axis and through the first calender roller rotational axis, and a straight line extending in perpendicular relation to the first rotational axis calender roller and through both the first calender roller rotational axis and the adjustment roller rotating axis.

12. The calender stack of claim 11, wherein the second calender roller is fixedly connected to the stand.

13. The calender stack of claim 11, wherein the toothing system of the stand is formed on at least one of the first and second guide rails.

14. The calender stack of claim 13, wherein the at least one of the first and second guide rails is fixed to a remaining part of the stand.

15. The calender stack of claim 13, wherein the at least one of the first and second guide rails is detachably fixed to a remaining part of the stand.

16. The calender stack of claim 11, further comprising a cooling device, at least one member selected from the group consisting of the first calender roller and the adjustment roller being connected to the cooling device for cooling the member.

17. A film production device, comprising:
an extruder configured to produce an extruded material web made of thermoplastic; and
a calender stack for an extruded material web made of thermoplastic, in particular a film web, said calender stack comprising a stand comprising a first guide rail set which includes two arc-shaped first guide rails and an untoothed first supplementary guide rail, and a second guide rail set which includes two arc-shaped second guide rails and an untoothed second supplementary guide rail, said stand having a toothing system, wherein one of the first guide rails of the first guide rail set is part of a rotational guide for rotating the stand, and wherein the other one of the first guide rails is toothed, a first calender roller configured for rotation about a first calender roller rotational axis and mounted on the stand, a second calender roller configured for rotation about a second calender roller rotational axis, said second calender roller being fixed to the stand and forming with the first calender roller a calender, an adjustment roller configured for rotation about an adjustment roller rotational axis and mounted on the stand, a supporting device, said stand being rotatably mounted on the supporting device such that during rotation of the stand the first calender roller rotational axis remains stationary, a drive unit interacting in a positive-fitting manner with the toothing system on the stand, so that the stand is automatically rotatable, and a guide carriage guided on the other one of the first guide rails and mounting the adjustment roller on the stand for movement on a circular arc which is defined by a centre in coincidence with the first calender roller rotational axis, said guide carriage moving on the first supplementary guide rail such that the adjustment roller and the second calender roller are positionable at a wrap-around angle of less than 75°, wherein the stand is configured to enable positioning of the adjustment roller at an inclination angle of at least 55° when the first and second calender roller rotational axes are oriented horizontally with respect to each other, with the inclination angle being formed between a horizontal extending in perpendicular relation to the first calender roller rotational axis and through the first calender roller rotational axis, and a straight line extending in perpendicular relation to the first rotational axis calender roller and through both the first calender roller rotational axis and the adjustment roller rotating axis,
said calender stack arranged downstream of the extruder in a material flow direction for smoothing the material web.

18. The film production device of claim 17, wherein the second calender roller is fixedly connected to the stand.

19. The film production device of claim 17, wherein the toothing system of the stand is formed on at least one of the first and second guide rails.

20. The film production device of claim 19, wherein the at least one of the first and second guide rails is fixed to a remaining part of the stand.

21. The film production device of claim 19, wherein the at least one of the first and second guide rails is detachably fixed to a remaining part of the stand.

22. The film production device of claim 17, wherein the calender stack includes a cooling device, at least one member selected from the group consisting of the first calender roller and the adjustment roller being connected to the cooling device for cooling the member.

23. A method for the production of a film, comprising:
producing an extruded material web made of thermoplastic; and
smoothing the material web with a calender stack as set forth in claim 11, as the material web is in contact with the first calender roller about a wrap-around angle, wherein the wrap-around angle is less than 75°.

24. The method of claim 23, further comprising controlling a temperature of at least one of the first calender roller and the adjustment roller to a temperature that is below a glass transition temperature of the thermoplastic.

25. The method of claim 23, wherein the thermoplastic is transparent.
